(19) United States
(12) Patent Application Publication
(10) Pub. No.: US 2006/0140452 A1
(43) Pub. Date: Jun. 29, 2006

(54) Computer user detection apparatus and associated method

(75) Inventors: Jeffrey Raynor, Edinburgh (GB); Brian Douglas Stewart, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Ltd., Marlow (GB)

(21) Appl. No.: 11/300,144

(22) Filed: Dec. 14, 2005

(30) Foreign Application Priority Data
Dec. 15, 2004 (EP) 04257808.8

(51) Int. Cl. G06K 9/00

(52) U.S. Cl. 382/115

(57) ABSTRACT

A detection apparatus is for a computer to detect the presence or absence of a computer user. The absence of a user can trigger a computer display to power down, while the detected presence of a user can trigger the display to power back up, and, optionally, require a log in. The detection apparatus may operate automatically and thus may provide a reliable way of saving power and/or ensuring security of computer data.

### FIELD OF THE INVENTION

The invention relates to a computer user detection apparatus and a method for detecting the new presence or absence of a computer user.

### BACKGROUND OF THE INVENTION

To save on power consumption, computers operate “screen saver” programs whereby the computer's display can be shut down or operated in a low power mode when a computer user stops using the computer. A screen saver program is usually set to power down the display after a predetermined period of inactivity, which it uses as a measure of when a user is absent. A user's presence is then detected by the resumed operation of the computer, for example, by detecting the pressing of a key or the movement of a mouse.

It may be particularly important to reduce the power consumed by the screen of a laptop or other wireless computing device, as the screen accounts for a large portion of the device's overall power consumption. For example, a laptop's screen may account for approximately half of its overall power consumption.

Some screen savers have a facility whereby once the screen saver is deactivated, the user is required to re-enter their username and/or password in order to regain access to the computer's functions. This helps increase the security of information and to control access to the computer's functions.

However, the predetermined time that must elapse before a screen saver becomes operative means that a certain amount of power is always wasted while the computer is waiting for the time to elapse. If a user leaves the screen momentarily, this time also represents a window for unauthorized access to the computer. The predetermined time cannot be made very short, as this would result in the computer's screen being shut down each time the user pauses during his operation of the computer.

It is therefore desirable to have another form of user detection that is automatic, acts to save power, and, optionally, helps to safeguard the computer's security.

### SUMMARY OF THE INVENTION

A first aspect of the invention may be to provide a computer user detection apparatus comprising one or more linear arrays of light sensing elements, a circuit or circuit means arranged to obtain an output representative of light incident on the or each linear array, and a processor or signal processing means arranged to ascertain a new presence or absence of a computer user based on the output from the or each linear array. The computer user detection apparatus may further comprise an output interface operable to send command signals to a computer to selectively adjust the mode of operation of the computer's screen and/or to log out a user from the computer based on the assertion of a new absence or presence of a user.

The computer user detection apparatus may comprise two linear arrays of light sensing elements or two pairs of linear arrays of light sensing elements arranged at opposing portions of a substrate on which the apparatus is embodied. The or each linear array of light sensing elements may be a subset of a two dimensional array of light sensing elements.

The two dimensional array of light sensing elements may have a width of less than one hundred and twenty light sensing elements, and a length of less than one hundred and sixty light sensing elements. The processor or signal processing means may be hard or soft coded with a detection algorithm for ascertaining a new presence or absence of a computer user based on the output from the or each linear array.

The detection algorithm may include one or more sub-algorithms selected from the group comprising a motion detection algorithm, a focus detection algorithm, and a color detection algorithm. Preferably, the mode of operation of the computer's screen may be adjustable to a first mode when a user is detected, and a second mode when a user is not detected with the power consumption of the display being less in the second mode than in the first mode. The output interface may send a command signal to the computer via any one of the following communication interfaces: USB, I²C, SPI, interrupt output, or any suitable wireless interface.

A second aspect of the invention may be to provide a method of detecting the presence or absence of a computer user. The method may comprise providing one or more linear arrays of light sensing elements, and obtaining an output representative of light incident on the or each linear array. The method may further comprise processing the output to ascertain a new presence or new absence of a computer user based on the output from the or each linear array.

The method may further comprise providing an output interface, and sending command signals from the output interface to a computer to selectively adjust the mode of operation of the computer's screen and/or to log out a user from the computer based on the assertion of a new absence or presence of a user. The processing of the output to ascertain a new presence or new absence of a computer user based on the output from the or each linear array may comprise performing a detection algorithm. The algorithm may comprise one or more sub-algorithms selected from the group comprising a motion detection algorithm, a focus detection algorithm, and a color detection algorithm.

The motion detection algorithm may comprise determining frame by frame changes in intensity of outputs from the or each linear array of light sensing elements, comparing the changes with a threshold, and, if the changes exceed the threshold, asserting the new presence or new absence of a computer user. Prior to asserting the new presence or new absence of a computer user, there may be a measuring of a reference intensity and a performing of a frame-by-frame normalization based on the reference intensity.

The focus detection algorithm may be used to detect a new presence or absence of a computer user at a threshold distance from a computer display. The focus detection algorithm may comprise a training component that learns the typical distance of the computer user from the computer display.

The color detection algorithm may comprise a color balancing component to compensate for variations in scene illumination. The color detection algorithm may comprise a training component that learns the typical skin tone of the computer user. The color detection algorithm and the focus detection algorithm may operate to verify the presence of a computer user having predetermined skin tone properties, and being at a predetermined distance from a computer display.

A motion detection algorithm may also operate, and all three motion, focus, and color detection algorithms may operate before asserting the new presence or absence of a computer user. The motion threshold and/or one or more of a focus threshold and a color threshold used for detection of a new presence of a computer user may be different from the threshold used for detection of a new absence of a computer user.

The method may further comprise using a first algorithm for detection of a new computer user presence or a new computer user absence, and, when the first algorithm indicates a new presence or absence, using one or more further algorithms to verify the new presence or absence. The or each linear array of light sensitive elements may be subsets of a two dimensional array of light sensitive elements.

The motion detection algorithm may ignore motion in a specified region of space. The method may further comprise the step of operating a two dimensional array to recognize the presence of a human face. The step of recognizing the presence of a human face may comprise one or more of verifying the presence of eyes, checking for a round head in focus, and checking the height of a head. The step of obtaining an output from the or each linear array may be carried out at a frame rate equal to or less than five frames per second.

A third aspect of the invention may be to provide a computer comprising the computer user detection apparatus of the first object of the invention. The computer may be programmed to carry out the method of the second object of the invention.

### BRIEF DESCRIPTION OF THE DRAWINGS

The invention will now be described, by way of example, with reference to the accompanying drawings, in which:

FIG. 1 shows an image sensor in accordance with a first embodiment of the invention;

FIG. 2 shows an image sensor in accordance with a second embodiment of the invention;

FIG. 3 shows an image sensor in accordance with a third embodiment of the invention;

FIG. 4 illustrates how the image sensor of FIG. 3 could be used;

FIG. 5 shows an image sensor in accordance with a fourth embodiment of the invention;

FIG. 6 shows an image sensor in accordance with a fifth embodiment of the invention; and

FIG. 7 shows the image sensor of FIG. 6 without a frame store.

### DETAILED DESCRIPTION OF THE PREFERRED EMBODIMENTS

The invention provides a computer user detection apparatus that checks for the presence of a real computer user in a specific location, that is, in front of a computer screen.

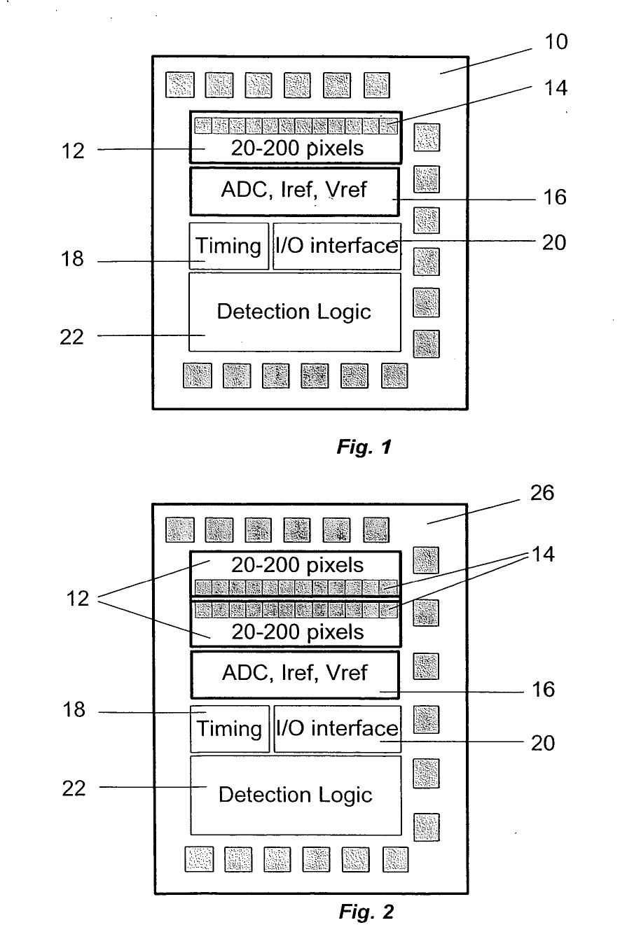

FIG. 1 illustrates a detector device 10 used in a first embodiment of a computer user detection apparatus. The detector device 10 comprises a linear, i.e. a one-dimensional, array 12 of light sensing elements 14, which in this embodiment are pixels. A circuit or circuit means including an analogue to digital (A/D) converter or an A/D conversion means 16 and a timing circuit 18 are provided to obtain an output of light incident on the or each linear array. The detector device 10 may also comprise an output interface 20. The output from the linear array 12 is interpreted by a processor or processing means comprising a detection logic processor 22, the operation of which will be described in more detail below.

The array 12, together with the circuit or circuit means 16, 18, and the optional output interface 20 together can be considered as a sensor. A linear array 12 is used to reduce the complexity of the data processing, so that the sensor and the detection logic processor 22 can be made very small. With such a compact system, it may be practical to combine the sensor and the detection logic processor 22 onto a single detector device 10. This also helps reduce the cost of the detection apparatus which makes use of the detector device 10.

The array 12 of the detector device 10 shown in FIG. 1 may have between 20 and 200 pixels, depending on how the detection logic 22 is arranged to operate. It will be appreciated that the size of the array could be adjusted outside the above range if required for any specific application of the detector apparatus.

In various alternative embodiments, the light sensing elements 14 may be standard linear type pixels (3 transistor, 4 transistor), logarithmic type pixels, or extended dynamic range light-frequency conversion type pixels, or the like, and may be monochrome or colored. FIG. 2 illustrates a detector device 26 used in a second embodiment of the detection apparatus. Components thereof that are similar to those shown in FIG. 1 are illustrated with like reference numerals. The detector device 26 of FIG. 2 is similar to the detector device 10 shown in FIG. 1, except that there are two linear arrays 12. This increases the area and complexity of the detector device 26 as compared to that illustrated in FIG. 1, but only to a small degree.

Having two linear arrays 12 rather than one also permits the use of readout columns that are not multiplexed. This is advantageous when the light sensing elements 14 comprise extended dynamic range light to frequency conversion pixels, as such cannot be simply multiplexed.

In a conventional image sensor, pixels are arranged next to each other in a grid to ensure that an entire scene is captured and can be reproduced in an image, i.e. a pictorial representation of an entire scene. However, the addition of a second linear array 12 of light sensing elements 14 does not serve the purpose of sampling an entire image, but serves the purpose of increasing the volume of space that the sensor observes. Having two (or more) lines of pixels allows the system to observe two (or more) “slices” of space, which is advantageous for a number of applications. For example, such a system would be able to detect the head of either a taller person or of a shorter person without the need to adjust the sensor. Thus, the reliability of the system is improved.

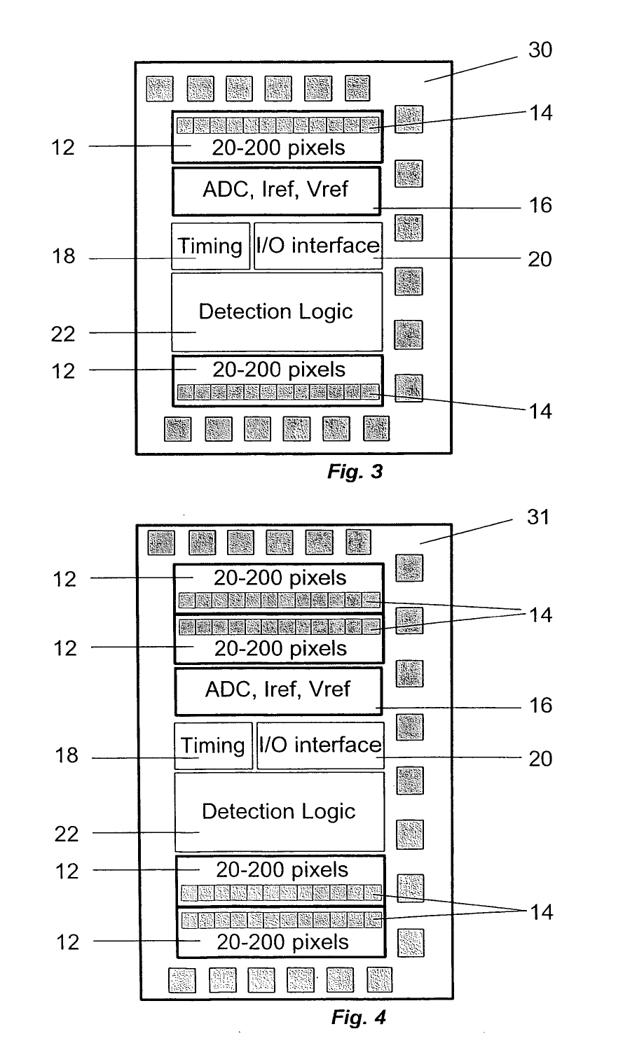

FIG. 3 illustrates a detector device 30 used in a third embodiment of a detection apparatus. Components thereof that are similar to those shown in FIGS. 1 and 2 are illustrated with like reference numerals.

In FIG. 3, the displacement between the two arrays 12 of light sensing elements 14 is increased with respect to their displacement as shown in FIG. 2, such that they are arranged at opposing portions of a substrate on which the detector device 30 (and thus the detection apparatus) is embodied. It is described above how having two (or more) lines of light sensing elements allows the system to observe two (or more) “slices” of space, which provides a more reliable system. The arrangement of FIG. 3 increases this reliability by producing the greatest possible distance between the observed regions (for a given lens) without having to include an image sensor of the size to fill the region between the two arrays 12 of light sensing elements 14.

It is to be understood that by arranging the arrays 12 at opposing portions, we mean that they are merely spaced apart enough to give advantageous effects in regard to increasing reliability by imaging different “slices” of space. That is, they do not have to be spaced apart as far as is physically possible. For example, each array 12 could be positioned between the detection logic 22 and the I/O interface 20.

Similarly, it is possible to have several linear arrays 12 of light sensing elements 14 on the device, where each linear array 12 is arranged to observe a single slice of space, and focus detection outputs of the lines could be combined for a more reliable system. For example, FIG. 4 illustrates a detector device 31 according to a fourth embodiment of a detection apparatus. Components thereof that are similar to those shown in FIGS. 1-3 are illustrated with like reference numerals.

In the detector device 31 of FIG. 4, two sets of linear arrays 12 are provided at opposing portions of a substrate on which the detector device 31 (and thus detection apparatus) is embodied. Having two lines in each set enables color space measurements using a Bayer pattern array of color sensitive pixels, and also enables an increased accuracy for a focus detection scheme, as each set of arrays 12 comprises two linear arrays that are close together to provide better edge detection. Again, the illustrated arrays 12 do not and cannot serve the purpose of sampling an entire image.

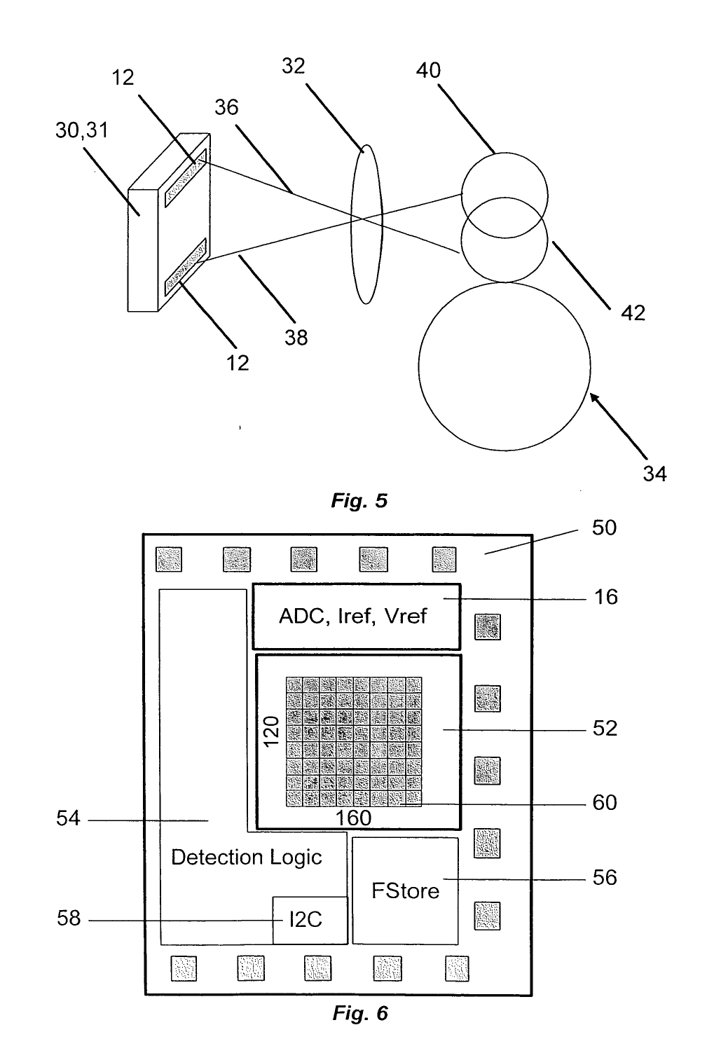

FIG. 5 shows how a detector device of FIG. 3 or FIG. 4 operates. The detector device 30, 31 is arranged to operate with a detection apparatus comprising an optical element 32 (shown here as a lens) to detect the presence of a user 34. The chief optical rays of the system are shown at 36 and 38. Hence, it can be seen that a user's head can be detected at a high position 40 or a low position 42. The displacement between the two sets of light sensing elements 14 means that a larger volume of space is monitored, so that the detection apparatus is more reliable to detect users 34 of differing heights, or to cope with changes in the posture of a user 34.

A fifth embodiment of a detector device is illustrated in FIG. 6. A detector device 50 comprises an image sensor 52, which includes an analogue to digital (A/D) converter or an A/D conversion means (not shown), a detection logic processor 54, a memory or memory means 56, which in a preferred embodiment is a frame store, and an output interface 58, which in this embodiment is an I²C output interface.

The memory or memory means 56 is used, for example, if a motion detection algorithm is employed to detect temporal changes in the image. The image sensor 52 comprises a two dimensional pixel array 60. In a first mode of operation, the full array is used to perform the functions of a digital camera, functioning for example as a web cam or for sending video clips over the Internet. The illustrated pixel array 60 comprises 120×160 pixels, for example. This size corresponds to the QVGA format. A higher resolution could be used, but would come at the expense of increasing the size of frame store 56. Another advantage of having fewer pixels in the pixel array 60 is that the pixel array 60 can be made larger at lower cost. Large pixel arrays 60 collect more light and hence are more sensitive than smaller ones. This allows the camera to be used in a low-light office environment and lower noise images to be produced from the sensor. The lower noise component of the resultant image helps to minimize false errors produced by the detection logic 54.

Using a two dimensional system enables more detection algorithms to be implemented and thereby a lower false-detection rate, and also enables the camera to be used for a wide range of applications (web conferencing, video Emails etc). Generally, the optics for a two dimensional sensor needs to be of better quality than a one dimensional (linear) sensor, especially if the unit is to be used for “visual” (e.g. web cam and/or photographic) purposes.

In a second mode of operation, the detector device 50 is switched to a user detection mode wherein a subset of the pixel array 60 is activated. This mode of operation thus consumes less power than the mode where the full pixel array 60 is used. The subset can include one or more linear arrays, which can be arranged as desired, for example to mirror the functionality provided by the embodiments illustrated in FIGS. 1-4. Furthermore, three side-by-side linear arrays can be used to give greater reliability, for example, by differentiating a horizontal edge from a vertical edge.

In a further embodiment, the pixel array 60 is very small and may be used for detection purposes rather than being suitable for video or photographic purposes. For example, the pixel array 60 could comprise 20 pixels by 20 pixels. The abovementioned QVGA format is the smallest recognized format for web-cameras, video e-mails, and the like, and an image sensor for dedicated use as a detection device can have a pixel array 60 that is smaller than 120×160 pixels, which size would be unsuitable for use as an image sensor, digital camera or web cam. An example array size that would give good functionality for a detection device but that may be unsuitable for other more general imaging purposes would be an array of twenty by twenty pixels.

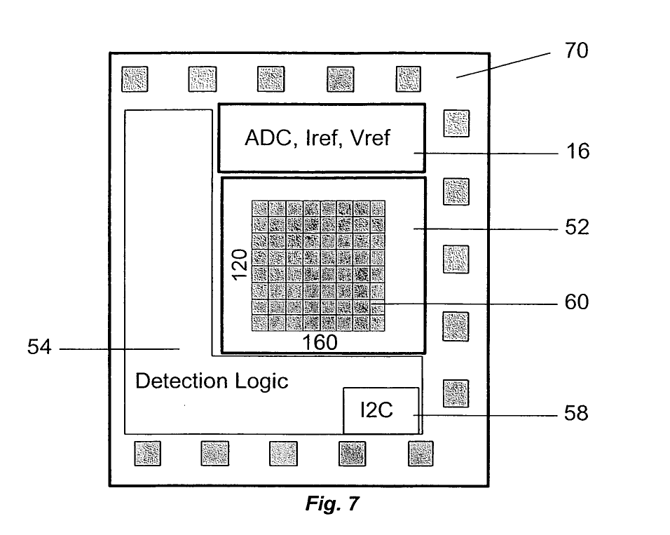

The device shown in FIG. 6 shows a “system on a chip”. Various system partitions can be implemented, for example, one chip comprising a sensor and ADC and another comprising detection logic and a frame store. A detector device 70 with no frame store is shown in FIG. 7.

In all the above embodiments, the sensor used in the detection system does not normally output motion pictures for a human observer. It is therefore possible and also advantageous to reduce the sensor's (and thus the system's) frame rate. The lower processing rate results in lower power consumption for the device, and the longer time between frames means that there are more photons to collect between frames, resulting in a more light sensitive system. For example, a typical web cam may have a frame rate of between fifteen and twenty-five frames per second, and so a user detection system could have a frame rate of below twenty-five frames per second. A system could practically operate at a rate of 0.1 to five frames per second.

It is also possible to have a variable frame rate. For example, when used with a computer, a “high” rate of five frames per second could be adopted when a computer user is present, and thereafter a “low” frame rate, for example, 0.1 frames per second, could be adopted when checking for the presence of a user.

Furthermore, a two dimensional array can be operated in a first mode for where the full image sensing array is enabled such that the image sensor can function as a digital camera or web cam. However, in a standby mode, only one or a few columns of the image sensing array are active in order to function as a detector device. This means that the power consumed by the array is greatly reduced. For example, a VGA sensor comprises a 640×480 pixel array. If only two columns were enabled in a standby mode, in principle, the power consumption in standby mode is only (2/640)=0.3% of the power consumption of the array in imaging mode. In practice, this power saving is slightly reduced by the effect of stray capacitance on the row-select lines, support circuitry (e.g. reference circuits such as bandgaps), and also the digital processing.

The detector devices described above may be used as a part of a user detection apparatus for a computer. A connection can be made between the detector and a host PC in a number of ways, for example by USB, I²C or SPI, Interrupt Output, a wireless interface, or the like.

USB is a very common interface, allowing a single bus to be shared between several peripherals. Using this interface would incur minimal cost penalties for the computer manufacturer. The disadvantage is that it is rather complex to implement—both on the sensor (where a cost penalty is incurred because of the increased size) and on the host PC (where a cost penalty is incurred because of the increased processing power required. This type of interface has the bandwidth (USB1=12 Mbps) to allow either the image to be streamed to the PC for the PC process, or at a lower speed for just the status information to be passed (e.g. user present, user not present).

I²C or SPI is a popular way of connecting low-speed devices. However, their low speed (100 kbps/400 kbps) prevents images from being streamed, but has lower requirements for both the sensor and host.

When using Interrupt Output, the device would use a dedicated digital line to indicate something had happened (e.g. user no longer present or user returned). This pin could be used alongside either USB or I²C/SPI interface. An advantage of this pin is that although it requires dedicated hardware on the host PC, it does not require activity from the host PC to monitor it. If the host PC is operational, no CPU activity is required to monitor the line—only to do something when something happens. If the host PC is not operational (e.g. in suspend, hibernate, sleep, or other low power mode), it is possible for the sensor's interrupt signal to wake up the PC.

Wireless network adapters, for example, IEEE 802.11a/b/g/i, Bluetooth, WiMax, or Zigbee, are becoming more popular on PCs, and so there is no cost penalty or re-design required to use one for the present purposes. If a PC has this interface, it is easy for the user to add such a device after purchase of the PC as no electrical connection need to be made.

The above detection apparatuses can use one or a number of different detection algorithms to function. These algorithms can be hard coded on the detection logic processors mentioned above, or can be implemented as a software code operable to configure a RAM component of a detection logic to control is operation.

The computer user detection device operates firstly while a user is present to verify that the user is present and to power down the display if the user leaves the computer, and secondly, to then check for the presence of a user and power up the display if a user is detected.

The first type of algorithm is a motion detection algorithm. Motion detection algorithms are known for use in image sensors such as digital cameras or web cams, where a normal two dimensional array is used. However, algorithms suitable for use with a two dimensional array can be adapted for use with a linear array. An example algorithm may comprise the following steps. Acquire a line of data L1 ([0:Nₚᵢₓ]−set of i pixel values, numbered from 0 to Npix. Wait for a predetermined period of time (integration time). Acquire another line of data L2 ([0:Nₚᵢₓ]). Compute the difference between the frames: for i=0 to Nₚᵢₓ; and Diff[i]=ABS(L1[i]−L2 [i]) (ABS=“absolute difference”). Calculate the sum of the differences (Sum of Absolute Differences): SAD_{reference}=0: For i=0 to Nₚᵢₓ; and SAD=SAD_{reference}+Diff[i]

Typically, a user is constantly moving (albeit by a small amount) in front of the machine, so there would always be some motion detected. Therefore, a predetermined threshold can be defined, and if the sum of absolute differences “SAD” is greater than the threshold, then it is determined that there has been a change in the scene, and the computer can then wake up the display.

One problem with a simple motion detection system is that it is “fooled” by a change in the system's exposure mechanism. One approach for this would be for the timing control system 18 (illustrated in FIGS. 1, 2, 3, 4, and part of the image sensor 52 of FIGS. 6 and 7) to output the settings at which it is operating to the detection logic 22, 54. These factors can then be included in the motion detection algorithm to make it independent of actual scene intensity.

For example, if a first frame has an exposure time of Tᵢₙₜ₁ and gain of G1, and a second frame has an exposure time of Tᵢₙₜ₂ and gain of G2, an example motion detection algorithm could function as follows. Acquire line of data L1[0:Nₚᵢₓ]. Normalize the data LN1[0:Nₚᵢₓ]=L1[0:Nₚᵢₓ]/(Tᵢₙₜ₁×G1). Wait a period of time. Acquire another line of data L2[0:Nₚᵢₓ]. Normalize the data LN2[0:Nₚᵢₓ]=L2[0:Nₚᵢₓ]/(Tᵢₙₜ₂×G2). Compute the difference between the frames: for i=0 to Nₚᵢₓ; and Diff[i]=ABS(LN1[i]−LN2[i]). Calculate the sum of the differences: SAD=0: For i=0 to Nₚᵢₓ; and SAD=SAD+Diff[i].

Again, if the sum of absolute differences “SAD” is greater than a pre-determined threshold, then there has been some change in the scene and the PC should wake up the display. Any of the pixel arrays of the above detector devices can be used to provide the outputs for a motion detection algorithm.

A further type of algorithm that can be used is a focus detection algorithm, as seen for example in U.S. Pat. Nos. 5,151,583; 5,404,163; or 6,753,919. It is possible to envisage a situation where a user was concentrating on the screen and hence there would be no motion. If the display was turned off at this point, it would break the user's concentration and be rather annoying, hence a more practical, but more computationally expensive algorithm would be to detect the focus of an object in front of the sensor.

A focus detection algorithm can be based on analyzing pixel data to give an indication of whether the focus is getting better or worse, or to provide a value that is the measure of the absolute focus. By arranging a detector device and suitable lens in front of the computer's monitor, the system could then detect if an object was present at a certain distance from the screen. The sensor and lens arrangement would usually be set up to observe the user's head or torso, for example.

This technique eliminates false detections caused by movement at a further distance, e.g. someone walking past the desk that the computer is on. The system could be set either for detecting objects at a pre-defined distance from the screen, or, alternatively, the system could learn or memorize the distance that the user typically operates at.

Hence, if the user was present, the computer would remain active and/or logged on to a network. However, if the user was to move away from the computer for a certain period of time, the display's backlight would turn off, eventually shutting down the PC or going into a hibernation/low power mode. Where security concerns are great, the system could also automatically log off.

When the user returned, the system could turn-on the display's lighting, turn on the display, or possibly even come out of low-power mode automatically. Any of the pixel arrays of the above detector devices can be used to provide the outputs for a focus detection algorithm.

A further type of algorithm that can be used is a color detection algorithm. While the focus algorithm is robust and can reliably detect the absence of a user, it may get confused by an object, e.g. the back of an office chair, which is within the system's field of view.

A method to overcome this is to detect the color of the object. Human skin tone (or flesh tone) is narrowly defined, even for people from different ethnic origins. A sensor that has color sensitive pixels is therefore able to detect the color of objects and detect if there are enough pixels of “skin tone” in front of the sensor to indicate the presence or absence of a user.

Color balancing techniques may be employed to compensate for variations in scene illumination, thus further improving accuracy. These techniques are in themselves well known and will not be described in further detail.

Any of the pixel arrays of the above detector devices can be used to provide the outputs for a focus detection algorithm. The outputs of any of the pixel arrays described above can also be used as the inputs for processing by further algorithms that can combine any two or all three of motion, focus, and color algorithms.

For example, a detector using only the color algorithm may well be fooled by the presence of suitably colored walls or other surfaces. It could therefore be combined with the focus algorithm to ensure that an event is only triggered when human skin tones are present at a particular distance from the screen.

In the embodiments illustrated in FIGS. 6 and 7, where a two dimensional array is used, more advanced implementations of the motion, focus and color algorithms are possible. If a motion detection algorithm is used, it is possible to program the detector device 50, 70 to ignore certain regions of the image, for example the background, where it is more likely that irrelevant motion is generated.

The focus detection and color space algorithms do not require temporal comparisons and hence the need for a frame-store is eliminated. This reduces the complexity of the device (increasing yield and reducing cost) and also reduces the area of the device (reducing cost)—depending on the technology used and the size of the imaging array, the frame store 56 can easily account for 10%-30% of the size of the device.

The two dimensional sensor shown in FIGS. 6 and 7 may also able to perform more spatially sensitive algorithms, for example, a facial recognition algorithm that could, among other tasks, check for the presence (or absence) of eyes in the image, check that there is a “round” head in focus, or check the height of the head. Such a two dimensional system may be more reliable, but more expensive than a one dimensional (linear) system. It may also be possible to include a biometric based face recognition that may be reliable enough to automatically log-on the user.

For all the above embodiments, a further power saving could be achieved with the selective use of the appropriate algorithms. For example, if a detector system uses more than one type of algorithm, a first type of algorithm can be used at all times, and, when the first algorithm indicates that an event has occurred, the remaining algorithm(s) could be employed to confirm the event before the display is powered up or down. As the remaining algorithm(s) are not enabled for the majority of the time, their power consumption is negligible.

Furthermore, for each algorithm, the threshold used to detect the presence of a user could be different from the threshold used to detect the absence of a user. For example, while a user was present, the algorithm(s) would be used to ensure a high accuracy in user detection, but while the user was not present, the system could use the lowest resolution (and therefore the lowest accuracy and possibly lower power consumption) to see if there was possibly a user present.

This ensures that while the user is present and using the computer, the annoyance and inconvenience of unnecessary display power downs is minimized. However, while the user is not present, no inconvenience is caused if the screen accidentally flashes on for a while, and so the accuracy of user detection is not as important as the case when a user is present.

It will be appreciated that various modifications and improvements may be incorporated to the above without departing from the scope of the invention. In particular, the detector device which is herein described as being part of a computer user detection apparatus may be equally useful for operation with to other devices or in other situations, for example, as a general surveillance tool or monitoring device. The principles of the invention can also be used or varied to detect any desired object, rather than just being limited to the detection of a person. Similarly, the described algorithms may also be applied to other detector devices, for example surveillance equipment or a general monitoring device.

Furthermore, the principles of the invention can be applied to other detectors, such as one used to detect the movement of a hand at a predetermined distance and so function as a switch, operable by the waving of a hand, with no moving parts. In addition, making use of focus detection algorithms could result in a switch that has different responses depending on other factors, for example, the proximity of a hand to the switch. The embodiments of the invention may also be used as a tool for counting and measuring the speed of passing objects.

Also, it will be understood that while the “linear arrays” illustrated and described above are horizontal arrays, the invention may equally well be applied to linear arrays that are vertical. The practical issues involved in modifying the embodiments described above to vertical linear arrays from horizontal linear arrays are straightforward to one skilled in the art.

1-28. (canceled)

29. An apparatus for detecting the presence or absence of a computer user adjacent a computer screen, the apparatus comprising:
at least one array including a plurality of light sensing elements;
a circuit generating output data representative of light incident on said at least one array; and
a processor for detecting the presence or absence of the computer user adjacent the computer screen based on the output data from said circuit.

30. The apparatus of claim 29 further comprising an output interface coupled to said processor for sending command signals to a computer to selectively perform at least one of adjusting an operation mode of the computer screen and logging out the computer user.

31. The apparatus of claim 29 wherein said at least one array comprises at least one linear array.

32. The apparatus of claim 31 wherein said at least one linear array comprises a plurality of linear arrays arranged in a two dimensional array.

33. The apparatus of claim 32 wherein the two dimensional array of light sensing elements has a width of less than one hundred and twenty light sensing elements, and a length of less than one hundred and sixty light sensing elements.

34. The apparatus of claim 29 wherein said processor comprises at least one of a motion detection algorithm, a focus detection algorithm, and a color detection algorithm.

35. The apparatus of claim 29 wherein the computer screen is operable in a first high power mode and a second low power mode; and wherein said processor selectively operates the computer screen to be in the first high power mode when the computer user is detected and to be in the second low power mode when the computer user is not detected.

36. The apparatus of claim 29 wherein the output interface sends a command signal to the computer via at least one of a wired communication interface and a wireless communication interface.

37. A computer comprising:
a computer screen to receive a computer user adjacent thereto;
a plurality of light sensing elements; and
a processor for detecting the presence or absence of the computer user adjacent the computer screen based on said plurality of light sensing elements.

38. The computer of claim 37 further comprising an output interface coupled to said processor for sending command signals to selectively perform at least one of adjusting an operation mode of the computer screen and logging out the computer user.

39. The computer of claim 37 wherein said plurality of light sensing elements are arranged in at least one linear array.

40. The computer of claim 37 wherein said processor comprises at least one of a motion detection algorithm, a focus detection algorithm, and a color detection algorithm.

41. The apparatus of claim 37 wherein the computer screen is operable in a first high power mode and a second low power mode; and wherein said processor selectively operates the computer screen to be in the first high power mode when the computer user is detected and to be in the second low power mode when the computer user is not detected.

42. A method of detecting the presence or absence of a computer user adjacent a computer screen, the method comprising:
providing at least one array including a plurality of light sensing elements;
generating output data representative of light incident on the at least one array; and
processing the output data via a processor to detect a presence or absence of the computer user adjacent the computer screen based on the output data.

43. The method of claim 42 further comprising:
providing an output interface; and
sending command signals from the output interface to the processor to selectively perform at least one of adjusting an operation mode of the computer screen and logging out the computer user.

44. The method of claim 42 wherein the processing comprises using at least one of a motion detection algorithm, a focus detection algorithm, and a color detection algorithm.

45. The method of claim 44 wherein the motion detection algorithm comprises determining frame by frame changes in intensity of outputs from the at least one array, and comparing the changes with a motion threshold, and, if the changes exceed the motion threshold, detecting the presence or the absence of a computer user.

46. The method of claim 45 further comprising measuring a reference intensity and performing a frame by frame normalization based on the reference intensity prior to detecting the presence or absence of the computer user.

47. The method of claim 44 wherein the focus detection algorithm comprises detecting a presence or absence of the computer user based upon a threshold distance from the computer screen.

48. The method of claim 47 wherein the focus detection algorithm further comprises a first training component that learns a typical distance of the computer user from the compute screen.

49. The method of claim 44 wherein the color detection algorithm comprises a color balancing component to compensate for variations in scene illumination.

50. The method of claim 44 wherein the color detection algorithm comprises a second training component that learns a typical skin tone of the computer user.

51. The method of claim 44 wherein the color detection algorithm and the focus detection algorithm operate to verify the presence of the computer user having predetermined skin tone properties, and being at a threshold distance from the computer screen.

52. The method of claim 44 wherein the motion detection algorithm, the focus detection algorithm, and the color detection algorithm operate before detecting the presence or absence of the computer user.

53. The method of claim 44 wherein at least one of the motion threshold, a focus threshold, and a color threshold used for detection of the presence of the computer user is different for detecting the absence of the computer user.

54. The method of claim 44 further comprising using one of the motion detection algorithm, the focus detection algorithm, and the color detection algorithm for detection of the presence or the absence, and, when the presence or the absence is detected, using an unused algorithm to verify the presence or the absence.

55. The method of claim 42 wherein the at least one array comprises at least one linear array; and wherein the at least one linear array comprises a plurality of linear arrays arranged in a two dimensional array.

56. The method of claim 44 wherein the motion detection algorithm ignores motion in a specified region of space.

57. The method of claim 55 further comprising operating the two dimensional array to recognize a human face.

58. The method of claim 57 wherein the two dimensional array recognizes the human face by verifying a presence of eyes, checking for a round head in focus, and checking a height of a head.

59. The method of claim 42 wherein the output data is obtained at a frame rate equal to or less than five frames per second.
